(19) United States
(12) Patent Application Publication
(10) Pub. No.: US 2015/0350406 A1
(43) Pub. Date: Dec. 3, 2015

(54) METHOD AND DEVICE FOR CALENDAR REMINDING

(71) Applicant: Xiaomi Inc., Beijing (CN)

(72) Inventors: Ruixian ZHU, Beijing (CN); Botian Wang, Beijing (CN); Xiehao Bao, Beijing (CN)

(73) Assignee: Xiaomi Inc.

(21) Appl. No.: 14/616,939

(22) Filed: Feb. 9, 2015

Related U.S. Application Data
(63) Continuation of application No. PCT/CN2014/089280, filed on Oct. 23, 2014.

(30) Foreign Application Priority Data
May 28, 2014 (CN) 201410231033.7

(51) Int. Cl. H04M 1/725; G06F 3/048; G06Q 10/10; H04L 29/08

(52) U.S. Cl. CPC H04M 1/72566; H04L 67/10; G06F 3/048; G06Q 10/1095

(57) ABSTRACT

A method for calendar reminding includes searching for an associated item corresponding to a calendar reminder item containing an event content. The associated item includes an associated application identification. The method further includes calling an application corresponding to the associated application identification in the associated item. The application is used for accomplishing the event content.

### CROSS-REFERENCE TO RELATED APPLICATIONS

This application is a Continuation of International Application No. PCT/CN2014/089280, filed Oct. 23 2014, which is based upon and claims priority to Chinese Patent Application No. 201410231033.7, filed May 28, 2014, the entire contents of both of which are incorporated herein by reference.

### TECHNICAL FIELD

The present disclosure relates to communication and computer processing and, more particularly, to a method and device for calendar reminding.

### BACKGROUND

With the development of electronic technology, mobile terminals have been widely used and are upgraded frequently. Various applications (apps) are used on the mobile terminals, such as calendar (also referred to as an “electronic calendar”). Initially, the calendar merely provided a date inquiry for a user.

Nowadays, more functions have been integrated into the calendar, such as event reminder. In conventional technology, when it comes to the time to remind the user of an event, the terminal initiates a reminder to the user by ringing. The user then needs to turn off the ringing, view contents of the reminder event, and perform a corresponding operation to accomplish the reminder event.

### SUMMARY

In accordance with the present disclosure, there is provided a method for calendar reminding that includes searching for an associated item corresponding to a calendar reminder item containing an event content. The associated item includes an associated application identification. The method further includes calling an application corresponding to the associated application identification in the associated item. The application is used for accomplishing the event content.

Also in accordance with the present disclosure, there is provided a device for calendar reminding. The device includes a processor and a non-transitory computer-readable storage medium storing instructions. The instructions, when executed by the processor, cause the processor to search for an associated item corresponding to a calendar reminder item containing an event content. The associated item includes an associated application identification. The instructions further cause the processor to call an application corresponding to the associated application identification in the associated item. The application is used for accomplishing the event content.

Also in accordance with the present disclosure, there is provided a non-transitory computer-readable storage medium storing instructions. The instructions, when executed by a processor in a terminal, cause the terminal to search for an associated item corresponding to a calendar reminder item containing an event content. The associated item includes an associated application identification. The instructions further cause the terminal to call an application corresponding to the associated application identification in the associated item. The application is used for accomplishing the event content.

It should be understood that, both the general description above and the detailed description below are merely exemplary and explanatory, and do not limit the present disclosure.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a flow chart showing a method for calendar reminding according to an exemplary embodiment.

FIG. 2 is a schematic diagram showing a calendar according to an exemplary embodiment.

FIG. 3 is a schematic diagram showing a dialing interface according to an exemplary embodiment.

FIG. 4 is a flow chart showing a method for calendar reminding according to an exemplary embodiment.

FIG. 5 is a flow chart showing a method for calendar reminding according to an exemplary embodiment.

FIG. 6A is a block diagram showing a device for calendar reminding according to an exemplary embodiment.

FIG. 6B is a block diagram showing a device for calendar reminding according to an exemplary embodiment.

FIG. 7A is a block diagram showing a device for calendar reminding according to an exemplary embodiment.

FIG. 7B is a block diagram showing a device for calendar reminding according to an exemplary embodiment.

FIG. 7C is a block diagram showing a calling module according to an exemplary embodiment.

FIG. 7D is a block diagram showing a calling module according to an exemplary embodiment.

FIG. 8 is a block diagram showing a device for calendar reminding according to an exemplary embodiment.

FIG. 9 is a block diagram showing a device for calendar reminding according to an exemplary embodiment.

FIG. 10 is a block diagram showing a device for calendar reminding according to an exemplary embodiment.

FIG. 11 is a block diagram showing a device according to an exemplary embodiment.

### DESCRIPTION OF THE EMBODIMENTS

Embodiments consistent with the present disclosure include a method and device for calendar reminding. Methods consistent with the present disclosure can be implemented by a mobile terminal.

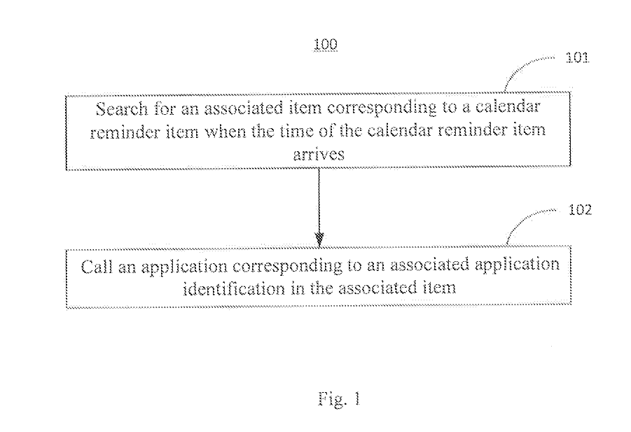

FIG. 1 is a flow chart showing an exemplary method 100 for calendar reminding consistent with embodiments of the present disclosure. As shown in FIG. 1, at 101, an associated item corresponding to a calendar reminder item is searched for when the time of the calendar reminder item arrives, i.e., when the calendar reminder item is triggered. The associated item includes an associated application identification. If the associated item corresponding to the calendar reminder item is found, the process proceeds to 102. If no associated item corresponding to the calendar reminder item is found, the process ends, and the user is reminded according to the calendar reminder item.

At 102, an application corresponding to the associated application identification in the associated item is called. The application is used to accomplish event contents in the calendar reminder item. Meanwhile, the calendar application may be closed.

As described above, consistent with the present disclosure, the user may not only set a calendar reminder item, but also set an associated item corresponding to the calendar reminder item. An exemplary process for setting the associated item is described below.

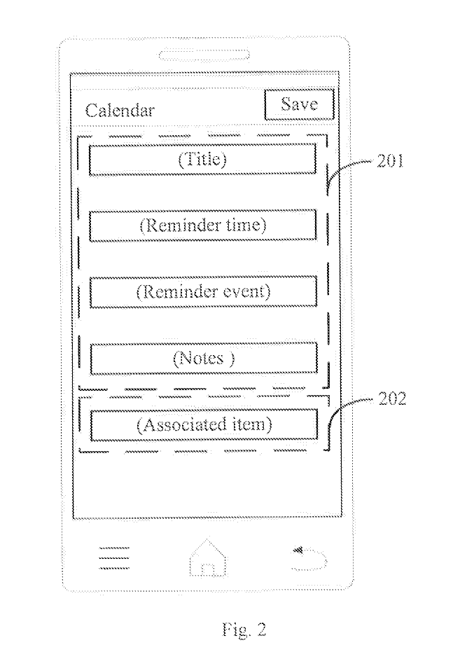

Consistent with embodiments of the present disclosure, the calendar application displays input boxes for the calendar reminder item and the associated item, as shown in FIG. 2. In FIG. 2, reference number 201 designates the input box for the calendar reminder item and reference number 202 designates the input box for the associated item. The calendar application then receives a first setting instruction for setting the calendar reminder item and a second setting instruction for setting the associated item. The user may set the calendar reminder item first then the associated item, or set the associated item first then the calendar reminder item. In some embodiments, the calendar reminder item includes, for example, an event title, an event content, a start time of the event, an end time of the event, a reminder time (e.g., reminding ten minutes before the event), repeat (e.g., reminding every day), a reminder mode (e.g., a ringing), etc., as well as other basic items.

For example, when the user inputs “Call Mr. Wang at 10:00” in the input box for the calendar reminder item, the device receives the first setting instruction including “Call Mr. Wang at 10:00” through the input box for the calendar reminder item. Similarly, when the user inputs a dialing item in the input box, which may be a selection box, for the associated item, the device receives the second setting instruction including the dialing item through the input box for the associated item. When it is 10:00, a ringing is output for reminding the user that there is a calendar reminder item, and the calendar reminder item “Call Mr. Wang at 10:00” is displayed. Meanwhile, if the dialing item in the associated item is found, the dialing application is called according to the dialing item, and then a dialing interface of the dialing application is displayed.

In some embodiments, the associated item further includes associated operation information. For example, for the dialing application, the associated operation information includes information for a dialing operation. For a player application, the associated operation information includes information for starting play.

In some embodiments, the user can set the associated application identification and the associated operation information in the associated item. Alternatively, the associated application identification and operation information can also be automatically set by the terminal by generating a third setting instruction for setting the associated item according to the calendar reminder item.

For example, the calendar reminder item is “Call Mr. Wang at 10:00.” By performing a semantic analysis on the calendar reminder item, it can be determined that “Call” corresponds to the dialing application. The corresponding relationship between keywords and the associated application identifications can be configured in advance, and the corresponding application can be determined according to the corresponding relationship. In this example, the third setting Instruction including the dialing application identification can be automatically generated. Moreover, the corresponding relationship among the keywords, the associated application identifications, and the associated operation information can be configured in advance. In this example, the third setting instruction including the dialing application identification and the dialing operation information can be automatically generated.

As another example, the calendar reminder item is “Watch sport channel at 10:00 p.m.” By performing a semantic analysis on the calendar reminder item. It can be determined that “the sport channel” is related to a television, and is thus related to a player that can play a television program. The corresponding relationship between the keyword “channel” and player A (the associated application identification) is configured in advance, where player A is a player that can play the television program. In this example, the third setting instruction including player A can be automatically generated. Moreover, the corresponding relationship among the keywords, the associated application identifications, and the associated operation information can be configured in advance. In this example, the third setting instruction including player A and the starting playing information can be automatically generated.

After the user inputs the calendar reminder item and the associated item, the calendar application can automatically save the items that have been set, and inquire such information during the item reminder process.

According to the present disclosure, a structure of the calendar is extended to support the setting of associated items, the inquiry during the reminder process, and the calling of applications. For example, a calendar application consistent with the present disclosure may support a calDav protocol (a calendar protocol), and extend the calDav protocol to include a CallWebview (web invocation) object and a CallIntent (intention invocation) object. The CallWebview object is used for calling network contents, e.g., calling a browser. Uniform Resource Locator (URL) addresses set by the user can be stored for calling the network contents. For example, the user may store a webpage link in the associated item. After the associated item is found, webpage contents corresponding to the stored webpage link are acquired and displayed to the user. The CallIntent object is used for calling a local application, e.g., an application that does not need to directly acquire Internet contents, for example, calling a player to play a video, etc. The set associated application identification can be stored. The second selling instruction for setting the associated item or the third setting instruction can be generated through the CallWebview or CallIntent object obtained by extending the calDav protocol.

In some embodiments, at 102, when the application corresponding to the associated application identification in the associated item is called, data related to the application in the calendar reminder item are also transmitted to the application. Such data are data required by the application for accomplishing the event contents. The application accomplishes the event contents in the calendar reminder item according to the data.

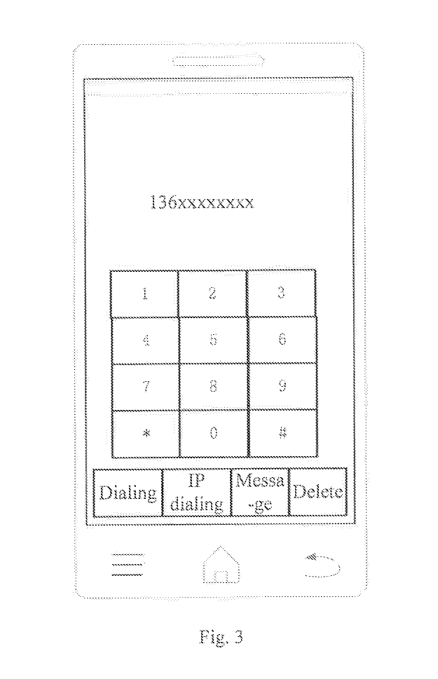

For example, if the calendar reminder item is “Call 136xxxxxxxx at 10:00,” and the associated item is the dialing item, then data “136xxxxxxxx” in the calendar reminder item is transmitted to the dialing item. After the dialing application is called, a dialing interface of the dialing application is displayed, and “136xxxxxxxx” is displayed on the dialing interface, as shown in FIG. 3. The user only needs to click a dialing key to initiate the phone call, without entering “136xxxxxxxx” again.

As another example, if the calendar reminder item is “Call San ZHANG at 10:00,” and the associated item is the dialing item, then data “San ZHANG” in the calendar reminder item is transmitted to the dialing item. After the dialing application is called, the dialing application automatically searches for the number of “San ZHANG” in an address book. If the number is found, “San ZHANG” and the number thereof are displayed on the dialing interface. The user only needs to click the dialing key without searching for or entering the number of San ZHANG again.

As described above, the associated item may further include associated operation information. In some embodiments, at 102, the associated operation information in the associated item is also transmitted to the application, so that the application processes the data according to the associated operation information.

In the example discussed above where the calendar reminder item is “Call 136xxxxxxxx at 10:00,” the associated item includes a dialing identification (the associated application identification) and dialing operation information (the associated operation information). When the calendar reminder item is triggered, the dialing application is called, and “136xxxxxxxx” and the dialing operation information are transmitted to the dialing application. The dialing application can dial the number “136xxxxxxxx” directly according to the dialing operation information after receiving the above information. The processes of entering the number and dialing can be automatically completed without manual input from the user. Consequently, the user's operation is simplified.

As another example, the calendar reminder item is “Watch sport channel at 10:00 p.m.,” and the associated item includes a player identification and starting playing information. When the calendar reminder item is triggered, the player is called and starts to play a program of the sport channel.

In some embodiments, the calendar consistent with embodiments of the present disclosure can support settings of multimedia contents. The multimedia contents include, but are not limited to, a background picture, a small icon, and calendar contents in an RTF format, etc. In some embodiments, the calendar reminder item and the associated item are displayed according to the preset multimedia contents. For example, during the process of outputting reminder information, the calendar reminder item and the associated item are displayed according to the preset multimedia contents. The reminder information includes information or an action for alerting the user of the reminder item, such as, for example, one or more of a ringing, a vibration, or a reminder screen (a static screen or a dynamic screen). When the user inputs a confirming reminder instruction, the outputting of the reminder information is stopped, and the application corresponding to the associated item is called.

In some embodiments, calendar data received by one device can be synchronized to a local calendar in another device if the calendar in the other device also supports a structure extension for synchronization. In this case, the method consistent with the present disclosure further includes receiving a synchronization instruction for a calendar (such a synchronization instruction is also referred to as a “calendar synchronization instruction) and synchronizing the calendar reminder item and the associated item to a specified device according to the synchronization instruction.

In some embodiments, the other device to which the calendar data are to be synchronized may not support all types of calendar data. For example, the other device may only support the calendar reminder item but not the associated item. In this scenario, the other device only receives the calendar reminder item to accomplish a general reminder function.

For example, the calendar reminder item “Call San ZHANG at 10:00” and the associated item “dialing item” are recorded in the calendar of device 1. During the synchronization process, “Call San ZHANG at 10:00” and “dialing item” are sent to device 2. Device 2 imports “Call San ZHANG at 10:00” and “dialing item” Into its local calendar, and generates a calendar reminder item “Call San ZHANG at 10:00” and an associated item “dialing item.” If the calendar of device 2 does not support the extended structure, device 2 may only import the calendar reminder item “Call San ZHANG at 10:00” into its local calendar.

After synchronizing the calendar data, the same calendar reminder item may be recorded in the calendars of multiple devices. In this case, when the reminder time arrives, the multiple devices may output the reminder information at the same time. At this time, the user may need to input the confirming reminder instruction to each device. In order to simplify the user's operations, the method consistent with the present disclosure may further include receiving a confirming reminder instruction on one device and sending the confirming reminder instruction by the one device to a specified device.

That is, the user can input the confirming reminder instruction to one device (also referred to as a “local device”), and then this device transmits the confirming reminder instruction to other devices. Thus, the local device and the other devices can almost stop outputting the reminder information at the same time, and can call the corresponding application. The user can use any one of the devices to enter into the application.

During the synchronization process of the calendar data, the local device can record the identifications of other devices that are being synchronized. These recorded devices are specified devices, to which the conforming reminder instruction is transmitted during the process of transmitting the confirming reminder instruction.

In order to ensure the effectiveness of the transmission, the local device may also check if a network connection can be established with the recorded device before transmitting the confirming reminder instruction, for example, the local device sends the identifications of the recorded devices to a router for confirming whether the network connection can be established. If the local device receives a confirming connection message sent by the router, it can be determined that the network connection can be established. Alternatively, the local device attempts to establish a direct connection with the recorded device, such as via Bluetooth. After the connection is successfully established, the confirming reminder instruction is transmitted to the specified device.

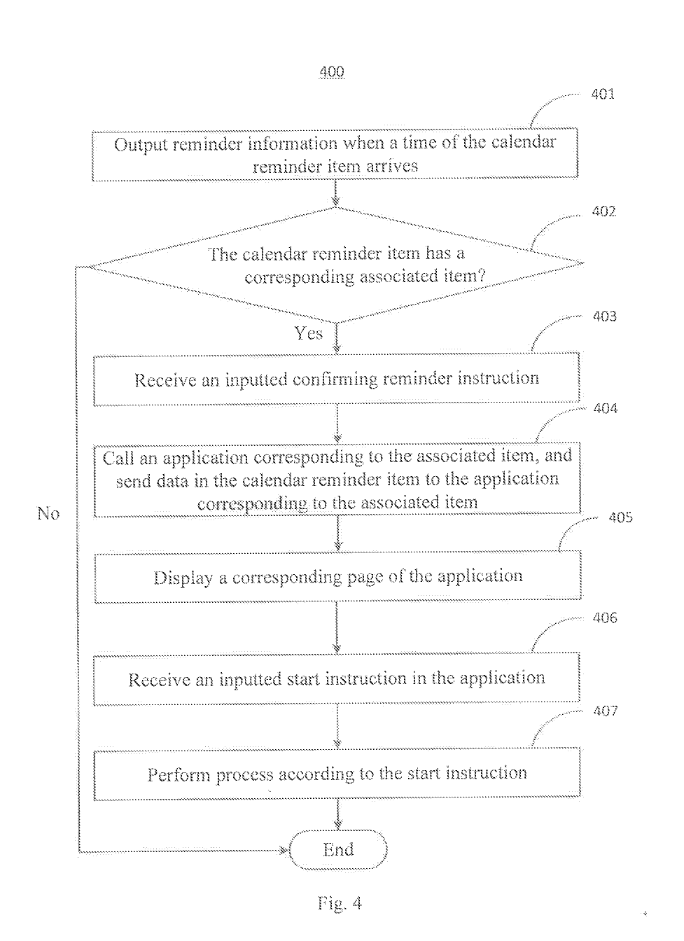

FIG. 4 is a flow chart showing an exemplary method 400 for calendar reminding consistent with embodiments of the disclosure. As shown in FIG. 4, at 401, reminder information is output when a time of the calendar reminder item arrives. At 402, whether the calendar reminder item has a corresponding associated item is inquired, if the calendar reminder item does not have a corresponding associated item, the process ends. In this scenario, the output of the reminder information is stopped when an inputted confirming reminder instruction is received, and the calendar application is closed. On the other hand, if at 402 it is determined that the calendar reminder item has a corresponding associated item, the process proceeds to 403, at which an inputted confirming reminder instruction is received, and the process further proceeds to 404. At 404, an application corresponding to the associated item is called, and data in the calendar reminder item are transmitted to the application corresponding to the associated item. At 405, a corresponding page of the application is displayed. At 406, an inputted start instruction is received in the application. At 407, a process is performed according to the start instruction.

For example, the calendar reminder item is “Watch a football game at 20:00,” and the associated item Is the sport channel of the player. When it is 20:00, the ringing is output to remind the user there is a calendar reminder item, and the calendar reminder item “Watch a football game at 20:00” may also be displayed according to the preset multimedia contents. After the user clicks to confirm, i.e., after the confirming reminder instruction is received, the ringing is stopped, the player is called, and the calendar application closed. When the player is called, the data “football game” of the calendar reminder item and the data “sport channel” of the associated Item arc sent to the player, and the interface of the sport channel is displayed directly. The player may determine which sport channels will play the football game according to an electronic program list, and lists the sport channels that will play the football game in a playlist. The user can click the identification of one of the sport channels, i.e., input the start instruction, then the player obtains a video of the sport channel through the network.

If there are multiple local players, one of them can be chosen according to factors such as the network condition.

As another example, the user can set a local video address and player in the associated item. After being called, the player can obtain the video data according to the video address. After the user clicks to start playing, the player starts playing the obtained video data.

As discussed above, the method 400 requires a start instruction from the user to start the process in the application corresponding to the associated item. In some embodiments, the application can automatically perform further processing without the start instruction from the user, as described below.

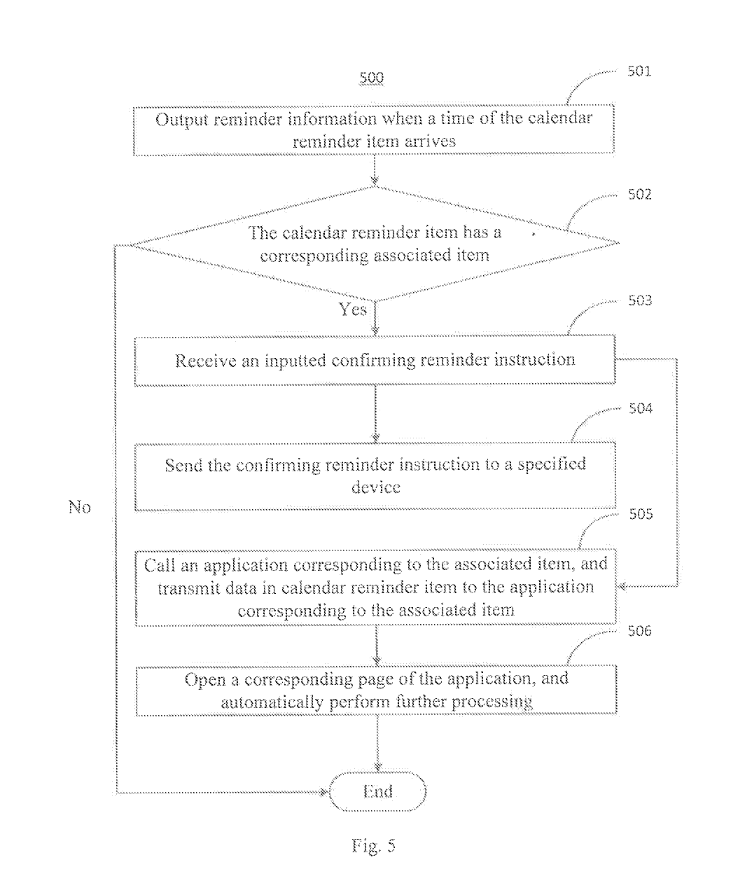

FIG. 5 is a flow chart showing an exemplary method 500 for calendar reminding consistent with embodiments of the disclosure. As shown in FIG. 5, at 501, reminder information is output when a time of a calendar reminder item arrives. At 502, whether the calendar reminder item has a corresponding associated item is inquired. If the calendar reminder item has a corresponding associated item, the process proceeds to 503. If the calendar reminder item has no corresponding associated item, the process ends. At 503, an inputted confirming reminder instruction is received. At 504, the confirming reminder instruction is sent to a specified device, for example, a device whose calendar has been previously synchronized.

For each device having the calendar reminder item and the associated item, the method 500 further includes calling an application corresponding to the associated item and transmitting data in the calendar reminder item to an application corresponding to the associated item (505), and opening a corresponding page of the application and performing further processing automatically (506).

For example, the calendar reminder item is “Get up at 7:30,” and the associated item is “player, playlist 1.” When it is 7:30, a ringing is output to remind the user to get up, and a picture representing getting up may also be displayed according to the preset multimedia contents. After the user clicks to confirm, i.e., after a confirming reminder instruction is received, on the one hand, the confirming reminder instruction is sent to the specified device to instruct it to stop outputting the ringing and to perform the subsequent processing; on the other hand, the local device stops outputting the ringing, calls the player according to the associated item, and sends “playlist 1” to the player. After being called, the player automatically plays the contents in “playlist 1.” For example, the player repeatedly plays songs in “playlist 1.” In some embodiments, the player can also automatically play morning news according to the user's settings.

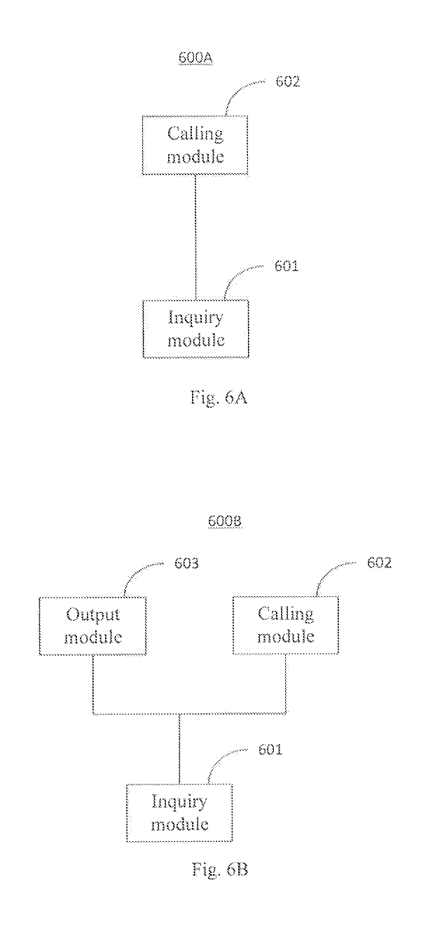

FIG. 6A is a block diagram showing an exemplary device 600A for calendar reminding consistent with embodiments of the disclosure. Referring to FIG. 6, the device includes an inquiry module 601 and a calling module 602. The inquiry module 601 is configured to search for an associated item corresponding to a calendar reminder item when a time of the calendar reminder item arrives. The associated item includes an associated application identification. The calling module 602 is configured to call an application corresponding to the associated application identification in the associated item. The application is used for accomplishing event contents in the calendar reminder item.

FIG. 6B is a block diagram showing an exemplary device 600B for calendar reminding consistent with embodiments of the disclosure. The device 600B is similar to the device 600A except that the device 600B further includes an output module 603 configured to output reminder information when the time of the calendar reminder item arrives.

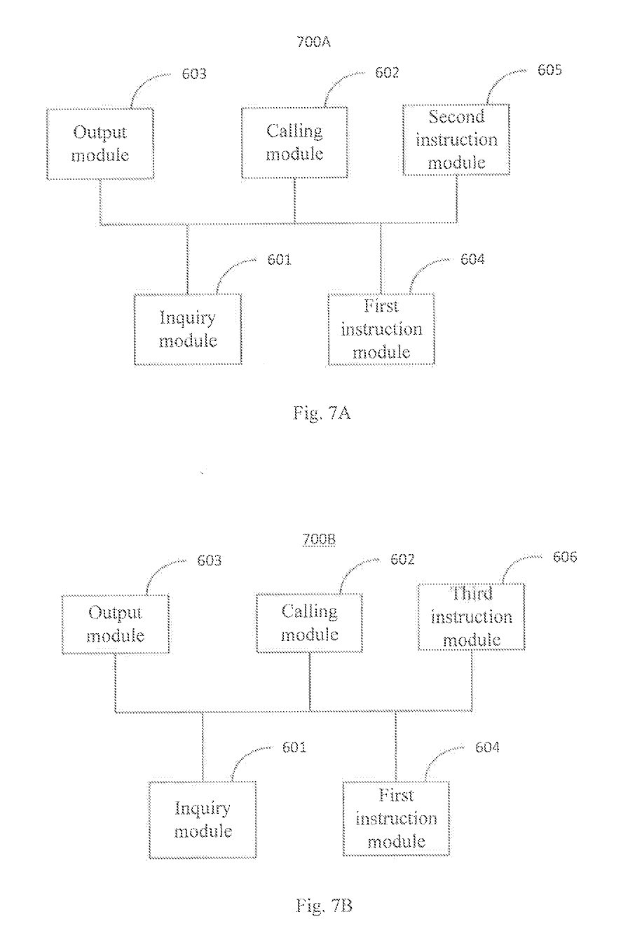

FIGS. 7A and 7B are block diagrams showing exemplary devices 700A and 700B, respectively. The devices 700A and 700B are similar to the device 600B. The device 700A further includes a first instruction module 604 configured to receive a first setting instruction for setting the calendar reminder item and a second instruction module 605 configured to receive a second setting instruction for setting the associated item. The device 700B further includes the first instruction module 604 and a third instruction module 606 configured to generate a third setting instruction for setting the associated item according to the calendar reminder item. In some embodiments, the second instruction module 605 receives the second setting instruction for setting the associated item through CallWebview or CallIntent object obtained by extending a calDav protocol.

FIG. 7C shows an example of the calling module 602. As shown in FIG. 7C, the calling module 602 includes a calling unit 6021 and a first transmission unit 6022. The calling unit 6021 is configured to call the application corresponding to the associated application identification in the associated item. The first transmission unit 6022 is configured to transmit data related to the application in the calendar reminder item to the application. The data being transmitted are data required by the application for accomplishing the event contents. The application accomplishes the event contents in the calendar reminder item according to the data.

In some embodiments, the associated item found by the inquiry module 601 further includes associated operating information. Thus, in another example shown in FIG. 7D, the calling module 602 further includes a second transmission unit 6023 configured to transmit the associated operating information in the associated item to the application, so that the application processes the data according to the associated operating information.

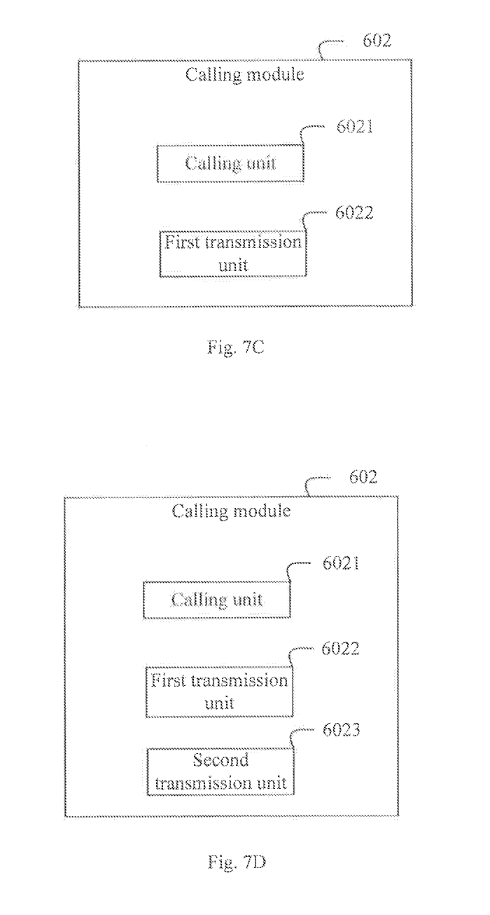

FIG. 8 is a block diagram showing an exemplary device 800 consistent with embodiments of the disclosure. The device 800 is similar to the device 700A, but further includes a display module 607 configured to display the calendar reminder item and the associated item according to preset multimedia contents.

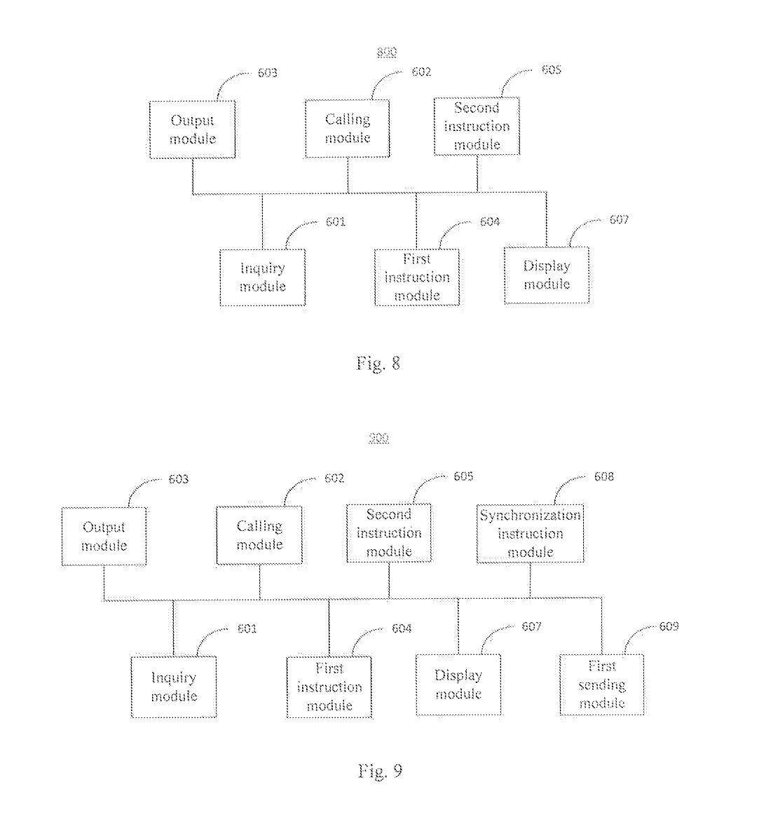

FIG. 9 is a block diagram showing an exemplary device 900 consistent with embodiments of the disclosure. The device 900 is similar to the device 800, but further includes a synchronization instruction module 608 and a first sending module 609. The synchronization instruction module 608 is configured to receive a synchronization instruction for a calendar. The first sending module 609 is configured to send the calendar reminder item and the associated item to a specified device according to the synchronization instruction, to synchronize the calendar of the specified device.

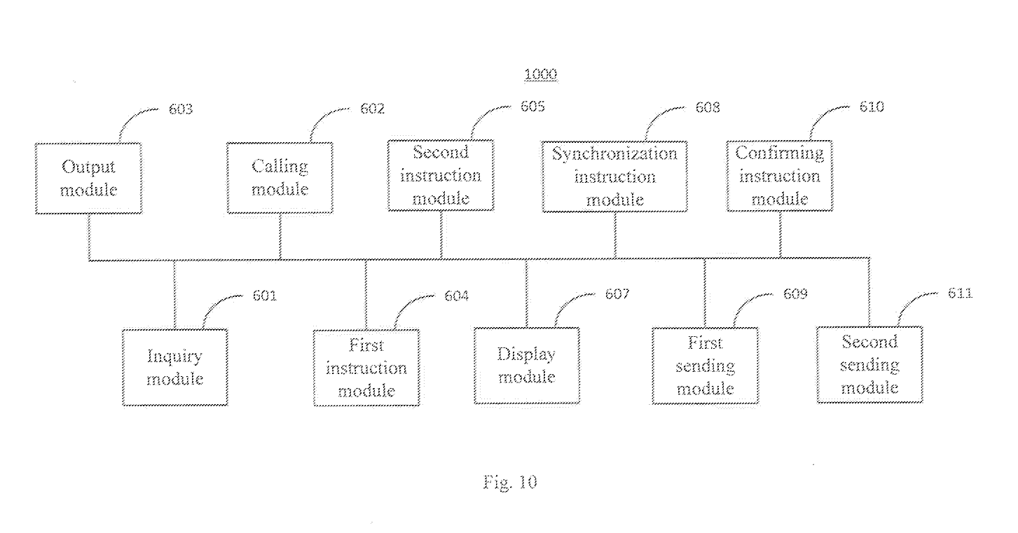

FIG. 10 is a block diagram showing an exemplary device 1000 consistent with embodiments of the disclosure. The device 1000 is similar to the device 900, but further includes a confirming instruction module 610 and a second sending module 611. The confirming instruction module 610 is configured to receive a confirming reminder instruction. The second sending module 611 is configured to send the confirming reminder instruction to the specified device.

The operations of individual modules in the devices shown in FIGS 6A-10 are similar to those described above in regard to the methods, and thus will not be repeated here.

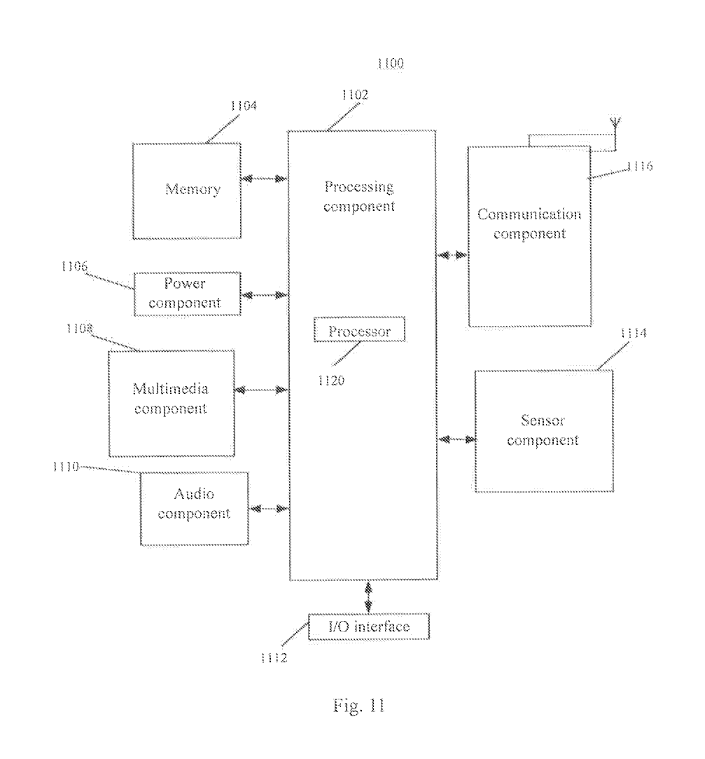

FIG. 11 is a block diagram showing an exemplary device 1100 for calendar reminding consistent with embodiments of the disclosure. The device 1100 may be, for example, a mobile phone, a computer, a digital broadcast terminal, a messaging device, a gaming console, a tablet, a medical device, exercise equipment, a personal digital assistant or the like.

Referring to FIG. 11, the device 1100 includes one or more of a processing component 1102, a memory 1104, a power component 1106, a multimedia component 1108, an audio component 1110, an input/output (I/O) interface 1112, a sensor component 1114, and a communication component 1116.

The processing component 1102 usually controls overall operations of the device 1100, such as the operations associated with display, telephone calls, data communications, camera operations, and recording operations. The processing component 1102 may include one or more processors 1120 to execute instructions to perform all or part of the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the device 1100. Examples of such data include instructions for any application or method operated on the device 1100, contact data, phonebook data, messages, pictures, videos, etc. The memory 1104 may be implemented using any type of volatile or non-volatile memory device or combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the device 1100. The power component 1106 may include a power management system, one or more power sources, and other components associated with the generation, management, and distribution of power in the device 1100.

The multimedia component 1108 includes a screen providing an output interface between the device 1100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 1108 includes a front camera and/or a rear camera. The front camera and/or the rear camera may receive an external multimedia datum while the device 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone (MIC) configured to receive an external audio signal when the device 1100 is in an operation mode, such as a call mode, a recording mode, and a voice identification mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, a button, and the like. The button may include, but not limited to, a home button, a volume button, a starting button, and a locking button.

The sensor component 1114 includes one or more sensors to provide status assessments of various aspects of the device 1100. For instance, the sensor component 1114 may detect an open/closed status of the device 1100, relative positioning of components, e.g., the display and the keyboard, of the device 1100, a change in position of the device 1100 or a component of the device 1100, a presence or absence of user contact with the device 1100, an orientation or an acceleration/deceleration of the device 1100, and a change in temperature of the device 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the device 1100 and other devices. The device 1100 can access a wireless network based on a communication standard, such as WiFi, 2G, or 3G, or a combination thereof. In one exemplary embodiment, the communication component 1116 receives a broadcast signal or broadcast associated information from an external broadcast management system via a broadcast channel. In one exemplary embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above method.

In exemplary embodiments, there is also provided a non-transitory computer readable storage medium including instructions, such as included in the memory 1104, executable by the one or more processors 1120 in the device 1100, for performing the above method. For example, the non-transitory computer-readable storage medium may be a ROM, a random access memory (RAM), a CD-ROM, a magnetic tape, a floppy disc, an optical data storage device, and the like.

A non-transitory computer-readable storage medium consistent with embodiments of the disclosure may store instructions that, when executed by one or more processors, cause the one or more processors to perform a method consistent with embodiments of the disclosure, such as those described above. The storage medium may be, for example, the memory 1104 shown in FIG. 11, and may be a ROM, a RAM, a CD-ROM, a magnetic tape, a floppy disc, an optical data storage device, or the like. A device consistent with embodiments of the disclosure may include a processor and a non-transitory computer-readable storage medium as described above.

The person skilled in the art may anticipate other solutions after consideration of the above description and implementation of the present disclosure. The present disclosure intends to cover any variation, usage, or modification which follow a general principle of the present disclosure and include common knowledge or usual technical means in the art.

It will be appreciated that the above embodiments are exemplary and the present disclosure is not limited thereto, and that various modifications and changes can be made without departing from the scope thereof. It is intended that the scope of the invention only be limited by the appended claims.

What is claimed is:

1. A method for calendar reminding, comprising:
searching for, by a processor in a local device, an associated item corresponding to a calendar reminder item containing an event content, the associated item including an associated application identification; and
calling, by the processor, an application corresponding to the associated application identification in the associated item, the application being used for accomplishing the event content.

2. The method according to claim 1, further comprising:
receiving a first setting instruction for setting the calendar reminder item; and
performing at least one of:
receiving a second setting instruction for setting the associated item; or
generating a third setting instruction for setting the associated item according to the calendar reminder item.

3. The method according to claim 2, wherein receiving the second setting instruction for setting the associated item includes:
receiving the second setting instruction for setting the associated item through a CallWebview object or a CallIntent object obtained by extending a calDav protocol.

4. The method according to claim 1, further comprising:
transmitting related data in the calendar reminder item to the application, the related data being related to the application and required by the application for accomplishing the event content; and
accomplishing, by the application, the event content in the calendar reminder item according to the related data.

5. The method according to claim 4,
wherein the associated item further includes associated operating information;
the method further comprising:
transmitting the associated operating information in the associated item to the application; and
processing, by the application, the related data according to the associated operating information.

6. The method according to claim 1, further comprising:
receiving a calendar synchronization instruction; and
synchronizing the calendar reminder item and the associated item to a specified device according to the calendar synchronization instruction.

7. The method according to claim 6, further comprising:
outputting reminder information to alert a user of the reminder item;
receiving a confirming reminder instruction inputted by the user; and
sending the confirming reminder instruction to the specified device.

8. A device for calendar reminding, comprising:
a processor; and
a non-transitory computer-readable storage medium storing instructions that, when executed by the processor, cause the processor to:
search for an associated item corresponding to a calendar reminder item containing an event content, the associated item including an associated application identification; and
call an application corresponding to the associated application identification in the associated item, the application being used for accomplishing the event content.

9. The device according to claim 8, wherein the instructions further cause the processor to:
receive a first setting instruction for setting the calendar reminder item; and
perform one of:
receiving a second setting instruction for setting the associated item; or
generating a third setting instruction for setting the associated item according to the calendar reminder item.

10. The device according to claim 9, wherein the instructions causing the processor to receive the second setting instructions for setting the associated item include instructions causing the processor to receive the second setting instruction through a CallWebview object or a CallIntent object obtained by extending a calDav protocol.

11. The device according to claim 8, wherein the instructions further cause the processor to:
transmit related data in the calendar reminder item to the application, the data being related to the application and required by the application for accomplishing the event content; and
accomplish the event content in the calendar reminder item according to the related data.

12. The device according to claim 11, wherein:
the associated item further includes associated operating information; and
the instructions further cause the processor to:
transmit the associated operating information in the associated item to the application; and
process the related data according to the associated operating information.

13. The device according to claim 8, wherein the instructions further cause the processor to:
receive a calendar synchronization instruction; and
synchronize the calendar reminder item and the associated item to a specified device according to the calendar synchronization instruction.

14. The device according to claim 13, wherein the instructions further cause the processor to:
output reminder information to alert a user of the reminder item;
receive a confirming reminder instruction inputted by the user; and
send the confirming reminder instruction to the specified device.

15. A non-transitory computer-readable storage medium storing instructions that, when executed by a processor in a terminal, cause the terminal to:
search for an associated item corresponding to a calendar reminder item containing an event content, the associated item including an associated application identification; and
call an application corresponding to the associated application identification in the associated item, the application being used for accomplishing the event content.
